(19) United States
(12) Patent Application Publication
(10) Pub. No.: US 2017/0047844 A1
(43) Pub. Date: Feb. 16, 2017

(54) POWER SUPPLY APPARATUS AND POWER SUPPLY CONTROL METHOD

(71) Applicant: FUJITSU LIMITED, Kawasaki-shi (JP)

(72) Inventor: Kazunori Hayami, Fukuoka (JP)

(73) Assignee: FUJITSU LIMITED, Kawasaki-shi (JP)

(21) Appl. No.: 15/193,569

(22) Filed: Jun. 27, 2016

(30) Foreign Application Priority Data
Aug. 11, 2015 (JP) 2015-158826

(51) Int. Cl. H02M 3/158; H02M 1/08

(52) U.S. Cl. CPC H02M 3/158; H02M 1/08

(57) ABSTRACT

A power supply apparatus includes: a power supply circuit, including a switch configured to perform switching at a frequency, configured to generate an output voltage to be supplied to a load device; a phase compensator configured to perform feedback control of switching duty of the switch in accordance with the output voltage, and change a response characteristic of the output voltage to a load fluctuation of the load device in accordance with a reference voltage and the output voltage; and a controller configured to apply a pilot signal over a frequency range to the reference voltage, monitor the output voltage, and control the response characteristic in accordance with the pilot signal and the output voltage.

### CROSS-REFERENCE TO RELATED APPLICATION

This application is based upon and claims the benefit of priority of the prior Japanese Patent Application No. 2015-158826, filed on Aug. 11, 2015, the entire contents of which are incorporated herein by reference.

### FIELD

The embodiment discussed herein is related to a power supply apparatus and a power supply control method.

### BACKGROUND

In communication apparatuses, such as routers and servers, printed circuit boards (PCBs) on which a large-scale integrated (LSI) chip, such as a field programmable gate array (FPGA) or a central processing unit (CPU), is mounted are used.

Related art is disclosed in Japanese Laid-open Patent Publication No. 2010-268608 or Japanese Laid-open Patent Publication No. 2004-180407.

### SUMMARY

According to an aspect of the embodiments, a power supply apparatus includes: a power supply circuit, including a switch configured to perform switching at a frequency, configured to generate an output voltage to be supplied to a load device; a phase compensator configured to perform feedback control of switching duty of the switch in accordance with the output voltage, and change a response characteristic of the output voltage to a load fluctuation of the load device in accordance with a reference voltage and the output voltage; and a controller configured to apply a pilot signal over a frequency range to the reference voltage, monitor the output voltage, and control the response characteristic in accordance with the pilot signal and the output voltage.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a power supply configuration in a printed circuit board (PCB);

FIG. 2 illustrates an example of a feedback loop within a point-of-load (POL) converter;

FIG. 3 illustrates an example of the relationship between a voltage fluctuation due to a load fluctuation and a zero crossing frequency of an open-loop transfer characteristic;

FIG. 4 illustrates an example of a model of a power supply circuit used in analysis;

FIG. 5 illustrates an example of a gain characteristic and a phase characteristic of an open-loop transfer characteristic exhibited when a load of the power supply circuit is configured with a resistance model;

FIG. 6 illustrates an example of a gain characteristic and a phase characteristic of an open-loop transfer characteristic exhibited when a load of the power supply circuit is configured with a constant current model;

FIG. 7 illustrates an example of a power supply apparatus;

FIG. 8 illustrates an example of a hardware configuration of a monitoring control circuit;

FIG. 9 illustrates an example of control performed by the monitoring control circuit;

FIG. 10 illustrates an example of a power supply apparatus;

FIG. 11 illustrates an example of a hardware configuration of a monitoring control circuit;

FIG. 12 illustrates an example of control performed by the monitoring control circuit;

FIG. 13 illustrates an example of supply of a control signal;

FIG. 14 illustrates an example of a phase compensator;

FIG. 15 illustrates an example of an equalization circuit;

FIG. 16 illustrates an example of parameters of a phase compensation circuit;

FIG. 17 illustrates an example of an open-loop transfer characteristic exhibited when a high current flows in the circuit illustrated in FIG. 16;

FIG. 18 illustrates an example of an open-loop transfer characteristic exhibited when a low current flows in the circuit illustrated in FIG. 16;

FIG. 19 illustrates an example of parameters of the phase compensation circuit;

FIG. 20 illustrates an example of an open-loop transfer characteristic exhibited when a high current flows in the circuit illustrated in FIG. 19;

FIG. 21 illustrates an example of an open-loop transfer characteristic exhibited when a low current flows in the circuit illustrated in FIG. 19;

FIG. 22 illustrates an example of improvements in response characteristic and stability; and

FIG. 23 illustrates an example of improvements in response characteristic and stability.

### DESCRIPTION OF EMBODIMENT

As semiconductor processes become finer, absolute values of power supply voltages of LSI chips decrease, and thus voltage setting accuracy is demanded. An increase in the degree of integration also results in a wide power supply current range extending from a current of several amperes to a high current of the order of several tens of amperes.

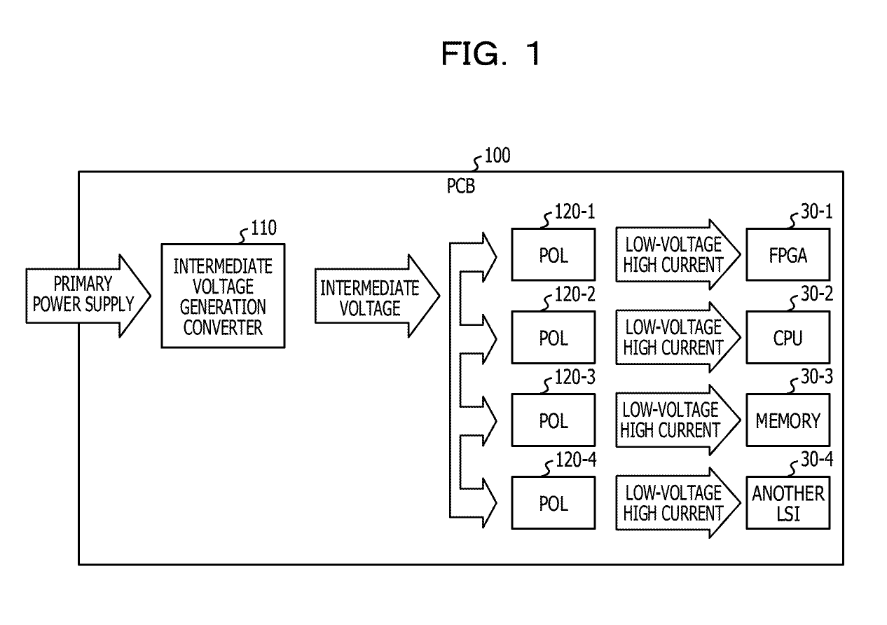

FIG. 1 illustrates an example of a power supply configuration in a printed circuit board (PCB). As illustrated in FIG. 1, a primary power supply voltage is distributed to supply a power supply voltage of an appropriate level to load devices 30-1 to 30-4 (hereinafter collectively called “load devices 30” as appropriate), such as a central processing unit (CPU) and a field programmable gate array (FPGA), that consume a high current. In an intermediate voltage generation converter 110, which is an end of a PCB 100, the primary power supply voltage is converted into an intermediate voltage. Step-down non-isolated direct current to direct current (DC-DC) converters disposed in proximity to the load devices 30 perform conversion into voltages appropriate to operating voltages of the respective load devices 30. The DC-DC converters are also referred to as point-of-load (POL) converters 120-1 to 120-4 (hereinafter collectively called “POL converters 120” as appropriate). In the POL converters 120, highly accurate output voltages, the stability of feedback, and high conversion efficiency are demanded.

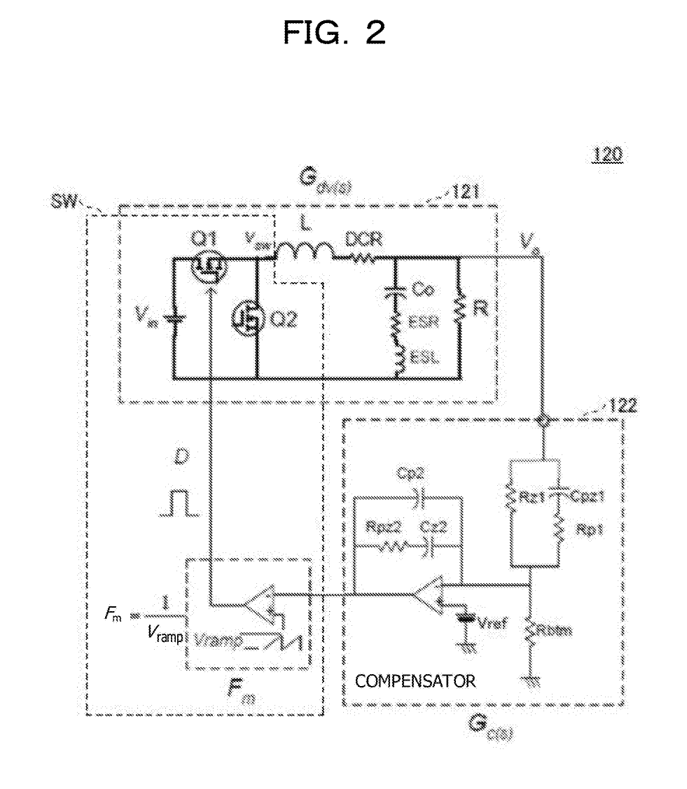

FIG. 2 illustrates an example of a feedback loop within a POL converter. As illustrated in FIG. 2, each POL converter 120 has a performance characteristic (open-loop transfer characteristic) derived from a closed loop transfer function. In the POL converter 120, a compensator 122 is used to stabilize feedback control in which an output voltage is maintained at a certain level. The compensator 122 compares an output voltage Vo from a power stage 121 with a reference voltage Vref, and controls a switching width of a conversion unit SW in accordance with a comparison result. The compensator 122 compensates for phase rotation due to inductance-capacitance (LC) components of the power stage 121, thereby stabilizing the performance of the POL converter 120. A monitoring point for the output voltage Vo is placed on a load device 30 side (remote sensing), thereby stabilizing a voltage supplied to a corresponding load device 30.

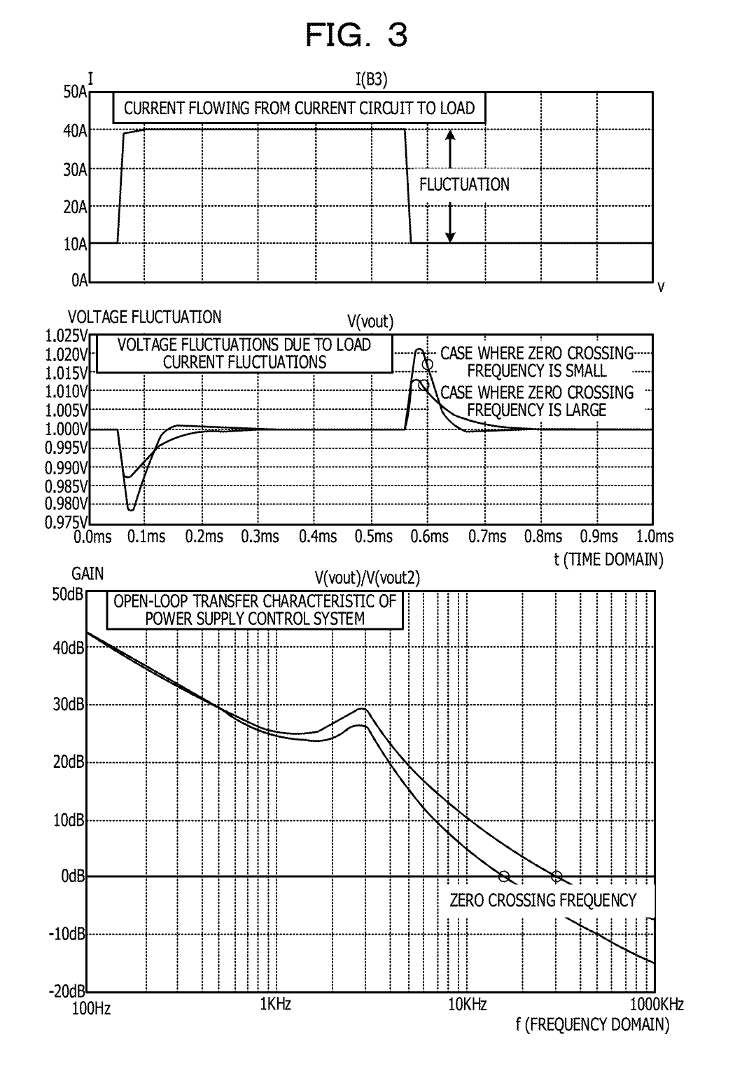

FIG. 3 illustrates an example of the relationship between a voltage fluctuation due to a load fluctuation and a zero crossing frequency of an open-loop transfer characteristic. As indicated in an upper graph, in a communication-related apparatus or a server apparatus, a consumption current significantly varies on the order of several tens of amperes due to a load fluctuation of communication traffic or a processor. A rate of change in current is 10 μsec, which is very fast. As indicated in a middle graph, a voltage varies due to a current fluctuation. The magnitude of a voltage fluctuation due to a current fluctuation is reduced by increasing a zero crossing frequency of an open-loop transfer characteristic of a feedback loop including the compensator 122.

As indicated in a lower graph, the open-loop transfer characteristic of the feedback loop varies due to, for example, an initial fluctuation in a power supply itself, a temperature fluctuation, the influence of parasitic inductance-resistance-capacitance (LRC) components in a power supply circuit pattern, or the amount of current of a load. For example, when a load current increases, feedback bandwidth narrows (the zero crossing frequency decreases) even in the same control circuit. Under conditions where the feedback bandwidth is narrow due to external factors, when a phase compensation circuit constant of the compensator 122 is optimized to set wide bandwidth/high gain, the bandwidth broadens excessively when the current decreases, and a phase margin disappears. For example, an output voltage may oscillate.

In a power supply circuit, to achieve the stability of feedback even when control bandwidth varies due to a change in external factors, a phase compensation circuit constant with which a response of the feedback loop is made slow to achieve the stability is selected. In this case, the power supply circuit may not be expected to produce the effect of suppressing a power supply fluctuation corresponding to a current fluctuation. Thus, measures may be taken in which a voltage fluctuation is suppressed by connecting a large capacitor to a power supply output, for example.

To adaptively respond to a fluctuation in load characteristic, instantaneous values of an output current and an output voltage of a voltage converter are detected, for example. An optimal parameter of a transfer function of a controller is obtained from these instantaneous values, and design values of elements, such as L, C, and R. The controller controls the voltage converter by using the obtained parameter of the transfer function. For example, a frequency characteristic having only a phase margin and no gain margin may be assigned to an open-loop transfer characteristic.

In the case where an open-loop transfer function of the voltage converter is obtained from instantaneous values of an output current and an output voltage of the voltage converter, and design values of the elements, such as L, C, and R, as described above, it may be difficult to determine a response characteristic and stability of the voltage converter. This is because there is a relationship where an improvement in the response characteristic reduces the stability, and because the degree of the response characteristic and the degree of the stability that achieve optimization vary according to a load characteristic, such as a resistance component or capacitance component of a load. For example, in the case where a range of fluctuations in the characteristic of a load connected (a range of load fluctuations) is assumed to be large, there may be no response characteristic and stability that satisfy the entire range of fluctuations in some cases.

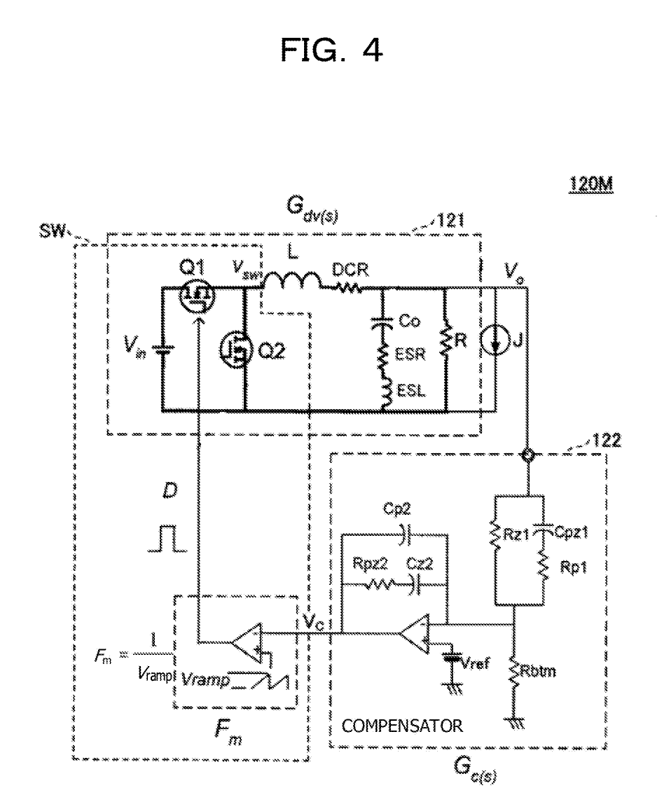

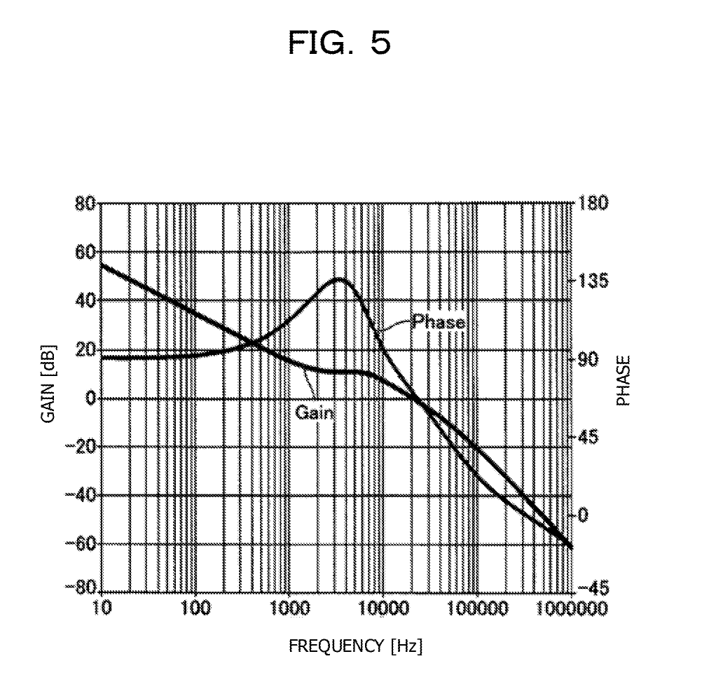

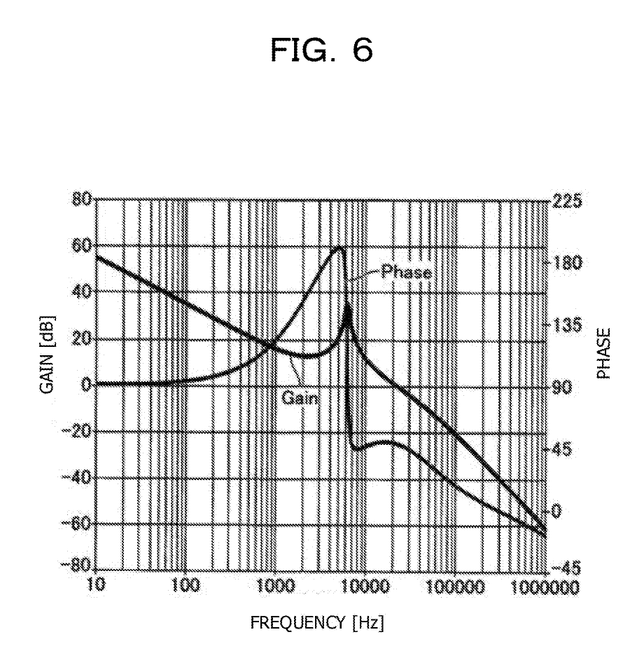

FIG. 4 illustrates an example of a model of a power supply circuit used in analysis. FIG. 5 illustrates an example of a gain characteristic and a phase characteristic of an open-loop transfer characteristic exhibited when a load of the power supply circuit is configured with a resistance model. FIG. 6 illustrates an example of a gain characteristic and a phase characteristic of an open-loop transfer characteristic exhibited when a load of the power supply circuit is configured with a constant current model. In the case where instantaneous values of an output current and an output voltage of a voltage converter, and design values of load elements, such as L, R, and C, are used as described above, it may be difficult to determine a response characteristic and stability of the voltage converter. The reasons are as follows.

(1) An open-loop transfer characteristic varies according to whether a load element has a voltage-dependent current characteristic (resistance load characteristic) or a voltage-independent current characteristic (constant current load characteristic) even if the load element consumes the same current.

(2) A capacitor within a device (a capacitor formed within an LSI package or on a silicon die, for example) is not disclosed, and thus it is difficult to estimate a capacitance value in advance.

(3) It is difficult to quantitatively grasp a parasitic inductance due to a power supply wiring pattern on a PCB.

(4) It is difficult to completely grasp variations in values of L, C, R elements, temperature characteristics, frequency characteristics, and so forth in advance.

The reason (1) is derived from an analysis result of a circuit model 120M illustrated in FIG. 4. The circuit model 120M illustrated in FIG. 4 has the same configuration as the POL converter 120 illustrated in FIG. 2. FIG. 4 illustrates the case where a load of the power stage 121 is modeled as a resistor R (“resistance model”) and the case where a load of the power stage 121 is modeled as a constant current J (“constant current model”). FIG. 5 illustrates a simulation result of an open loop exhibited when a current of 50 A is fed in “resistance model”. FIG. 6 illustrates a simulation result of an open loop exhibited when a current of 50 A is fed in “constant current model”. In FIGS. 5 and 6, the horizontal axis represents frequency (Hz), the left vertical axis represents gain (dB), and the right vertical axis represents phase (degree). A “Gain” line represents a gain characteristic, and a “Phase” line represents a phase characteristic.

As is clear from FIGS. 5 and 6, the open-loop transfer characteristic represented by a gain and a phase varies significantly between different types of loads of the POL converter 120 even in the case of the same current and the same voltage. A phase margin is represented by a value of the phase (or how many degrees the phase is from −180°) at a gain of zero (0 dB). Although the phase margin is 60° or greater in the resistance model in FIG. 5, the phase margin is about 45° in the constant current model in FIG. 6.

Thus, an open-loop transfer characteristic is not determined with accuracy by simply monitoring and using instantaneous values of an output current and an output voltage of the voltage converter, and the response characteristic of the voltage converter may not be improved.

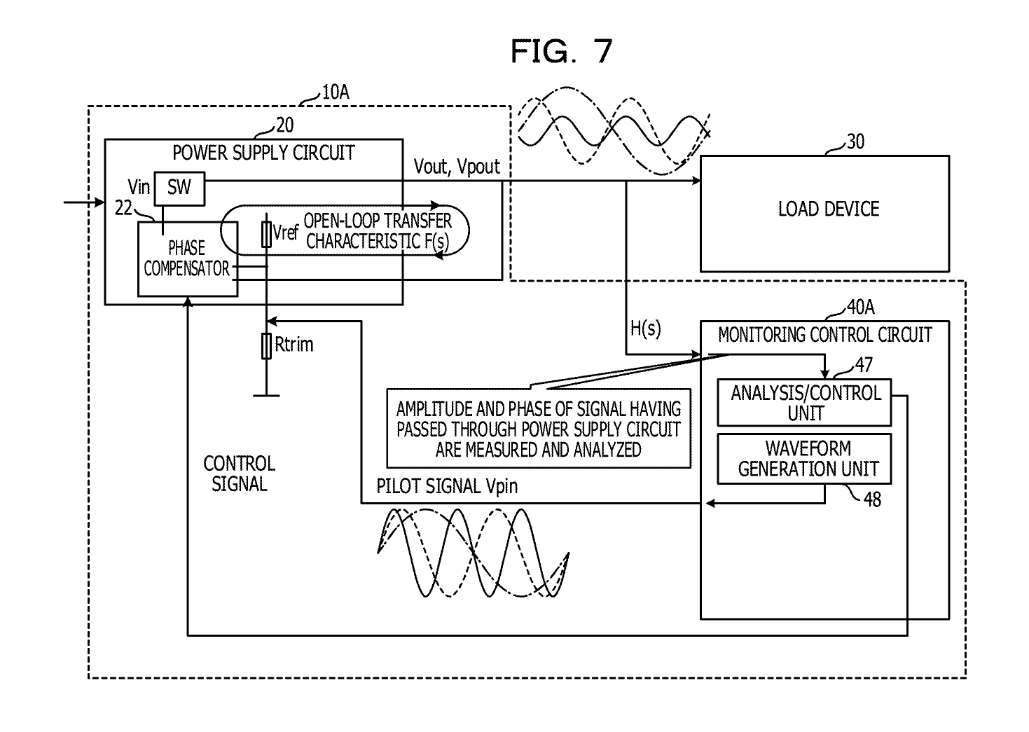

For example, measuring an open-loop transfer characteristic of a power supply circuit in real time while an apparatus is being operated may improve a response characteristic and stability of a power supply apparatus regardless of the type of a load. The measuring of an open-loop transfer characteristic may include, for example, (a) a method in which a pilot signal having a small amplitude enough to have no influence on the operation of a device is used, or (b) a method in which a measurement is performed using a response characteristic exhibited when a current of a load device 30, such as a CPU or FPGA, changes suddenly. Feedback control of a characteristic of the power supply circuit is performed based on a real-time measurement result of the open-loop transfer characteristic. For example, when a circuit constant or control parameter of a phase compensator is automatically switched or changed, the open-loop transfer characteristic is optimized, and the response characteristic of the power supply circuit may be improved. FIG. 7 illustrates an example of a power supply apparatus. In FIG. 7, an open-loop transfer characteristic of a power supply circuit 20 is measured in real time using a pilot signal by a monitoring control circuit 40A. This may improve a response characteristic and stability of the power supply circuit 20.

A power supply apparatus 10A includes the power supply circuit 20 and the monitoring control circuit 40A. The power supply circuit 20 may include an analog circuit like the circuit model 120M illustrated in FIG. 4, or part thereof may be firmware. The power supply circuit 20 including firmware as part may be referred to as “power supply module”. The power supply circuit 20 includes a phase compensator 22 and a conversion unit (switch unit) SW. The conversion unit SW may have the same configuration as the conversion unit SW illustrated in FIG. 4. The phase compensator 22 may be provided outside the power supply circuit 20.

When an intermediate voltage Vin is input from, for example, the intermediate voltage generation converter 110 (see FIG. 1) to the power supply circuit 20, an LRC circuit similar to that in FIG. 4 supplies a low-voltage, high-current output voltage Vout to a load device 30. Part of the output voltage Vout is fed back to the phase compensator 22 of the power supply circuit 20. The phase compensator 22 compares the output voltage Vout fed back with a reference voltage Vref to perform feedback control of switching duty of the conversion unit SW. A variable resistor Rtrim for trimming is interposed between the reference voltage Vref and the ground, and the phase compensator 22 is able to vary a response characteristic of the output voltage Vout of the power supply circuit 20 to a load fluctuation of the load device 30 in accordance with the reference voltage Vref and the output voltage Vout of the power supply circuit 20. A transfer characteristic of the open loop of the power supply circuit 20 is an open-loop transfer characteristic F(s).

The output voltage Vout of the power supply circuit 20 is also supplied to the monitoring control circuit 40A. The monitoring control circuit 40A includes an analysis/control unit 47 and a waveform generation unit 48. The analysis/control unit 47 outputs a control signal to the power supply circuit 20 in accordance with a monitoring result of the output voltage Vout. The waveform generation unit 48 sweeps the frequency of a pilot signal in accordance with the range of measurement frequencies, and generates a sine wave having the same phase and the same amplitude to supply an input pilot signal Vpin to the power supply circuit 20. Thus, the analysis/control unit 47 monitors the response characteristic of the power supply circuit 20 over an entire frequency band (see the lower graph in FIG. 3).

The input pilot signal Vpin is applied to an external control side of the variable resistor Rtrim of the power supply circuit 20, and an output pilot signal Vpout is superimposed on the output voltage Vout of the power supply circuit 20. The amplitude of the input pilot signal Vpin to be applied is set to a sufficiently small amplitude so that the output pilot signal Vpout having a minute amplitude superimposed on the output voltage Vout has no influence on the load device 30. The output pilot signal Vpout superimposed on the output voltage Vout depends on a frequency, and varies in phase and amplitude in comparison with the input pilot signal Vpin. The analysis/control unit 47 measures the amplitude and phase of the output pilot signal Vpout, and computes a transfer function H(s) from the input pilot signal Vpin to the output pilot signal Vpout. The analysis/control unit 47 calculates an open-loop transfer characteristic F(s) of the power supply circuit 20 by using the transfer function H(s).

When a rate of change in direct current of the output pilot signal Vpout with respect to the input pilot signal Vpin is defined as K (K=Vpout/Vpin), the relationship of an expression (1) holds between the transfer function H(s) from Vpin to Vpout and the open-loop transfer characteristic F(s) of the power supply circuit 20.

H(s)=K×F(s)/(1+F(s)) (1)

Thus, the open-loop transfer characteristic F(s) of the power supply circuit 20 is obtained by calculating the following expression (2).

F(s)=H(s)/(K−H(S)) (2)

The analysis/control unit 47 adjusts or changes a value of a load parameter of the phase compensator 22 in accordance with the open-loop transfer characteristic F(s) calculated in real time to optimize the open-loop transfer characteristic F(s).

In FIG. 7, based on the example where the power supply circuit 20 includes an analog circuit, the monitoring control circuit 40A is provided outside the power supply circuit 20. In the case where control of the power supply circuit 20 is performed in digital form, generation and application of a pilot signal, and computations of a transfer function H(s) and an open-loop transfer characteristic F(s) may be performed in a power supply module including the power supply circuit 20.

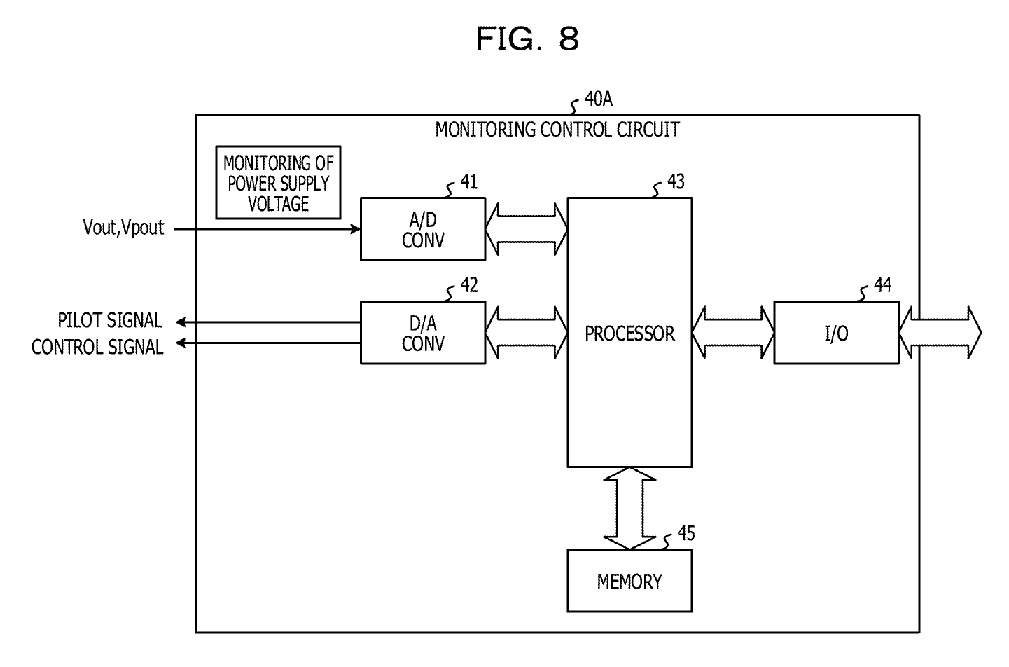

FIG. 8 illustrates an example of a hardware configuration of a monitoring control circuit. The monitoring control circuit illustrated in FIG. 8 may be the monitoring control circuit 40A illustrated in FIG. 7. The monitoring control circuit 40A includes an analog-to-digital (A/D) converter 41, a digital-to-analog (D/A) converter 42, a processor 43, an input/output (I/O) interface 44, and a memory 45. The A/D converter 41 performs digital conversion of the output voltage Vout (on which the output pilot signal Vpout has been superimposed) from the power supply circuit 20, and inputs it to the processor 43. The processor 43 executes functions of the analysis/control unit 47 and the waveform generation unit 48 which are illustrated in FIG. 7. The memory 45 records a measurement result of a pilot signal over an entire frequency band, and records a transfer function H(s) from Vpin to Vpout calculated by the processor 43. The processor 43 calculates a current open-loop transfer characteristic F(s) of the power supply circuit 20 from the transfer function H(s), and generates a control signal that optimizes the open-loop transfer characteristic. The processor 43 generates a pilot signal to be applied to the power supply circuit 20. The D/A converter 42 performs analog conversion of digital signals output from the processor 43, and outputs the pilot signal and the control signal.

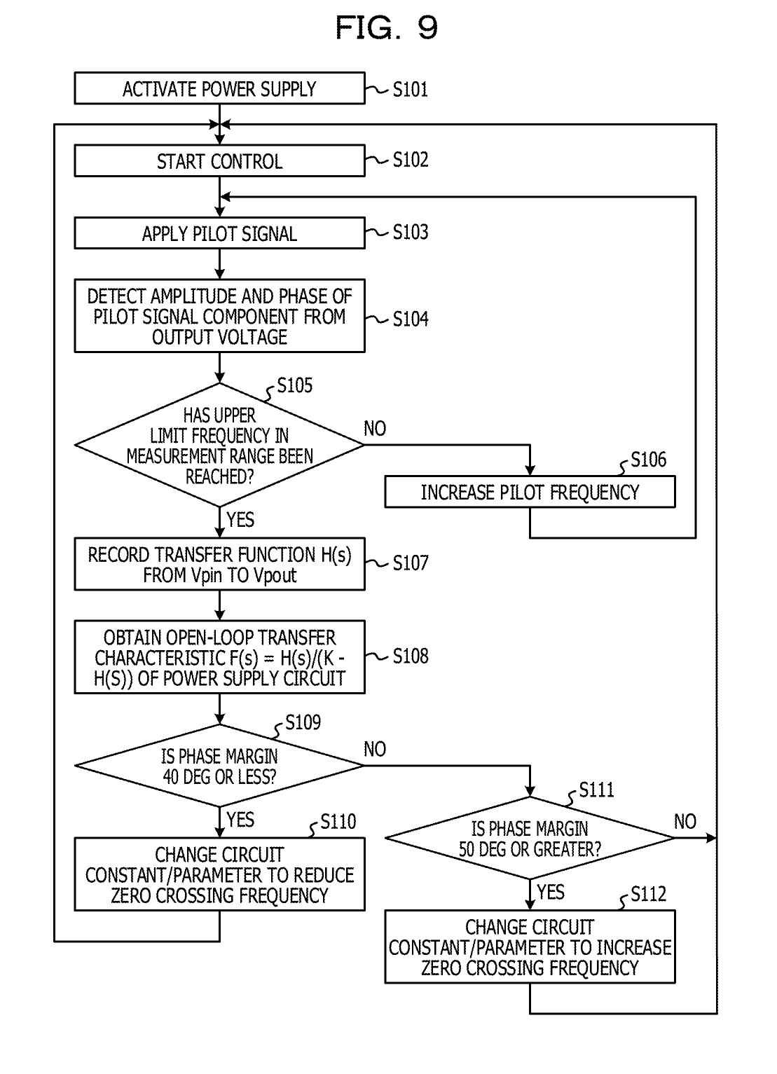

FIG. 9 illustrates an example of control performed by the monitoring control circuit. FIG. 9 is a flowchart illustrating optimization control of an open-loop transfer characteristic performed by the monitoring control circuit 40A illustrated in FIG. 7 or 8. When the power supply circuit 20 is activated (S101), control is started (S102). A pilot signal having the same phase and the same amplitude over a frequency band of a measurement range is applied to the power supply circuit 20, beginning with a low frequency, for example, (S103). Part of an output voltage Vout from the power supply circuit 20 is monitored, and the amplitude and phase of a pilot signal component contained in the output voltage Vout are detected (S104). As described above, the pilot signal having passed through the power supply circuit 20 has varied in phase and amplitude according to frequency. The frequency is increased by fixed step sizes until an upper limit frequency in the measurement range is reached (S105, S106), and application of a pilot signal and detection of the amplitude and phase of a pilot signal component contained in the output voltage Vout are repeatedly performed (S103, S104). When the upper limit frequency in the measurement range is reached (YES in S106), a transfer function H(s) from Vpin to Vpout is obtained and recorded in the memory 45 (S107). By using the transfer function H(s), an open-loop transfer characteristic F(s) of the power supply circuit 20 is calculated from the expression (2) (S108).

In the calculated open-loop transfer characteristic, it is determined whether or not a phase margin is a first threshold value or less (for example, 40° or less) (S109). A phase margin is a phase value (or how many degrees the phase is from −180°) at a gain of 0. When the phase margin is small, the stability of the output voltage of the power supply circuit 20 is lost, and oscillation is likely to occur. Thus, when the phase margin is 40° or less (YES in S109), a circuit constant or parameter of the phase compensator 22 is changed to reduce a zero crossing frequency, thereby giving higher priority to the stabilization of the output voltage than to response speed (S110). Subsequently, the process returns to S102, and the control is repeatedly performed.

When the phase margin is greater than 40° , it is determined whether or not the phase margin is a second threshold value or greater (for example, 50° or greater) (S111). When the phase margin is greater than 40° and less than 50° (NO in S111), it is determined that the phase margin is within an appropriate range, the process returns to S102, and the control is repeatedly performed. When the phase margin is 50° or greater (YES in S111), a circuit constant or parameter of the phase compensator 22 is changed to increase a zero crossing frequency (S112). An increase in zero crossing frequency increases response speed, and improves the capability of following a load fluctuation. Subsequently, the process returns to S102, and the control is repeatedly performed. The control illustrated in FIG. 9 is repeatedly performed while the power supply circuit 20 is operating, and thus the control flow forms a loop. The control ends at the time when the power supply circuit 20 is turned off.

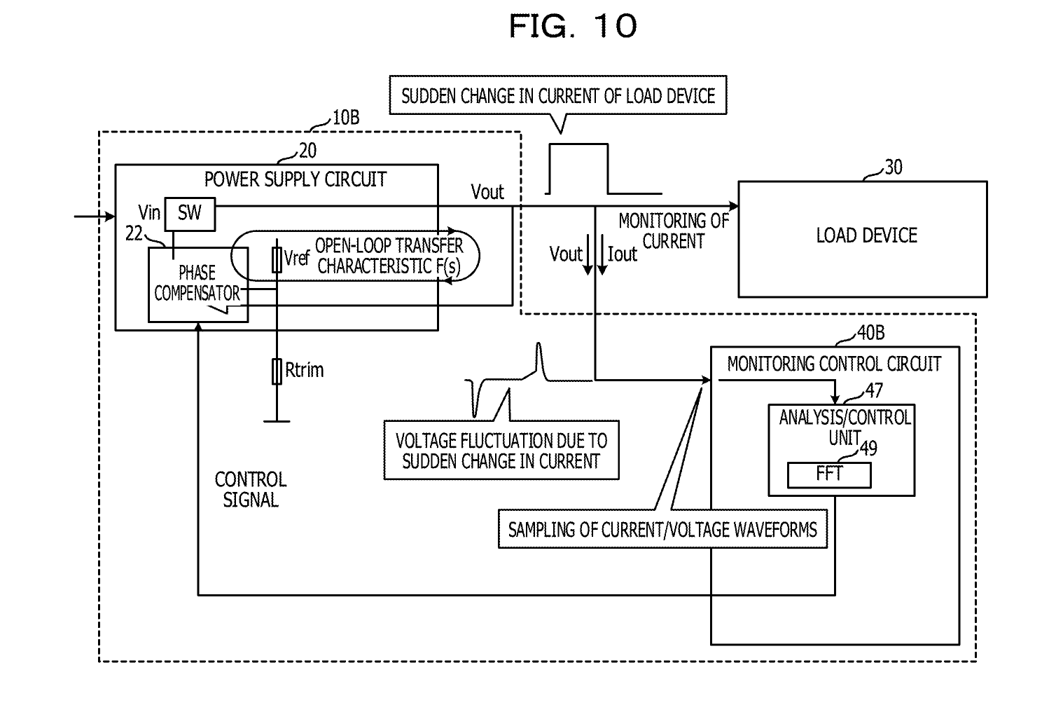

In this way, an open-loop transfer characteristic itself of the power supply circuit 20 is measured in real time by using a pilot signal, and a phase margin is maintained within an appropriate range. This may improve the response characteristic of the power supply circuit 20 and stabilize an output voltage. FIG. 10 illustrates an example of a power supply apparatus. For example, measuring an open-loop transfer characteristic of the power supply circuit 20 by using a change itself in current of the load device 30 occurring from some factor may improve a response characteristic and stability of the power supply circuit 20.

A power supply apparatus 10B includes the power supply circuit 20 and a monitoring control circuit 40B. The power supply circuit 20 may be the same as the power supply circuit 20 illustrated in FIG. 7. The power supply circuit 20 may be constituted by, for example, an analog circuit like the circuit model 120M illustrated in FIG. 4, or part of the power supply circuit 20 may be constituted by firmware. The power supply circuit 20 includes the phase compensator 22 and the conversion unit SW. The conversion unit SW may have the same configuration as the conversion unit SW illustrated in FIG. 4.

Part of an output voltage Vout of the power supply circuit 20 is supplied to the monitoring control circuit 40B. The monitoring control circuit 40B also monitors a current flowing to the load device 30 (referred to as “load current Iout”). The load current Iout changes suddenly when the amount of processing in an LSI increases, for example. The output voltage Vout of the power supply circuit 20 also varies due to a fluctuation in the amount of current consumed by the load device 30. A fluctuation waveform of the output voltage Vout of the power supply circuit 20 may be referred to as “output voltage response waveform”.

The analysis/control unit 47 of the monitoring control circuit 40B measures a current waveform of the load current Iout and a voltage waveform of the output voltage Vout. When the load current Iout varies beyond a certain level, the analysis/control unit 47 performs a fast Fourier transform (FFT) on the voltage waveform and the current waveform to obtain spectra in a frequency domain, and calculates a transfer function H(s) from Iout to Vout. A change in the output voltage Vout occurring is related to a change in the load current Iout by an output impedance Z(s) of the power supply circuit 20. This is represented by an expression of Z(s)=H(s). For example, Z(s) is defined by a feedback characteristic within the power supply circuit 20. When an open-loop transfer function of a feedback loop is defined as F(s), a relational expression of Z(s)=1/(1+F(s)) holds.

The transfer function H(s) from Iout to Vout is represented by the following expression (3).

H(s)=1/(1+F(s)) (3)

When the following expression (4) is calculated, an open-loop transfer characteristic F(s) of the power supply circuit 20 is obtained.

F(s)=(1−H(s))/H(S) (4)

The analysis/control unit 47 outputs a control signal that adjusts or changes a circuit constant or a value of a parameter of the phase compensator 22 in accordance with the open-loop transfer characteristic F(s) calculated in real time. This optimizes the open-loop transfer characteristic F(s) of the power supply circuit 20.

In FIG. 10, based on the example where the power supply circuit 20 includes an analog circuit, the monitoring control circuit 40B is provided outside the power supply circuit 20. In the case where control of the power supply circuit 20 is performed in digital form, sampling of a load current waveform and an output voltage waveform, and computations of a transfer function H(s) and an open-loop transfer characteristic F(s) may be performed in a power supply module including the power supply circuit 20.

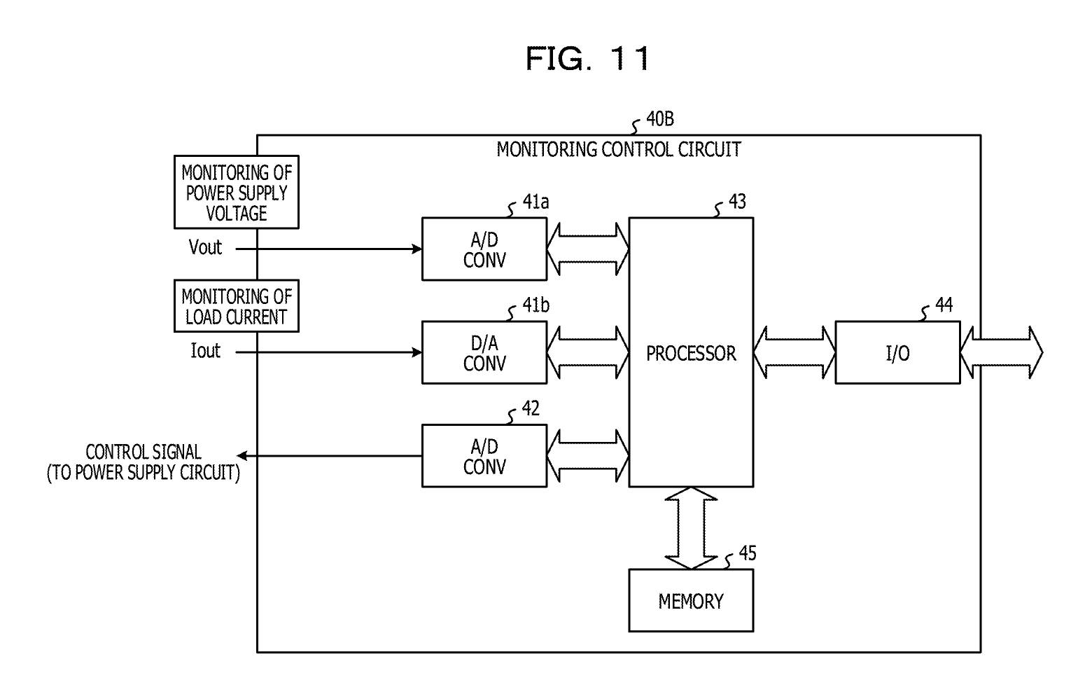

FIG. 11 illustrates an example of a hardware configuration of a monitoring control circuit. The monitoring control circuit illustrated in FIG. 11 may be the monitoring control circuit 40B illustrated in FIG. 10. The monitoring control circuit 40B includes A/D converters 41a and 41b, the D/A converter 42, the processor 43, the I/O interface 44, and the memory 45. The A/D converter 41a monitors an output voltage response waveform of the power supply circuit 20 to perform digital conversion (sampling), and supplies sampling results to the processor 43. The A/D converter 41b monitors a load current flowing to the load device 30 to perform digital conversion (sampling), and supplies sampling results to the processor 43.

The processor 43 executes functions of the analysis/control unit 47 (including an FFT processing unit 49) illustrated in FIG. 10. The memory 45 records a transfer function H(s) from Iout to Vout calculated by the processor 43. The processor 43 calculates a current open-loop transfer characteristic F(s) of the power supply circuit 20 from the transfer function H(s), and generates a control signal that optimizes the open-loop transfer characteristic. The D/A converter 42 performs analog conversion of a digital signal output from the processor 43, and outputs an analog control signal.

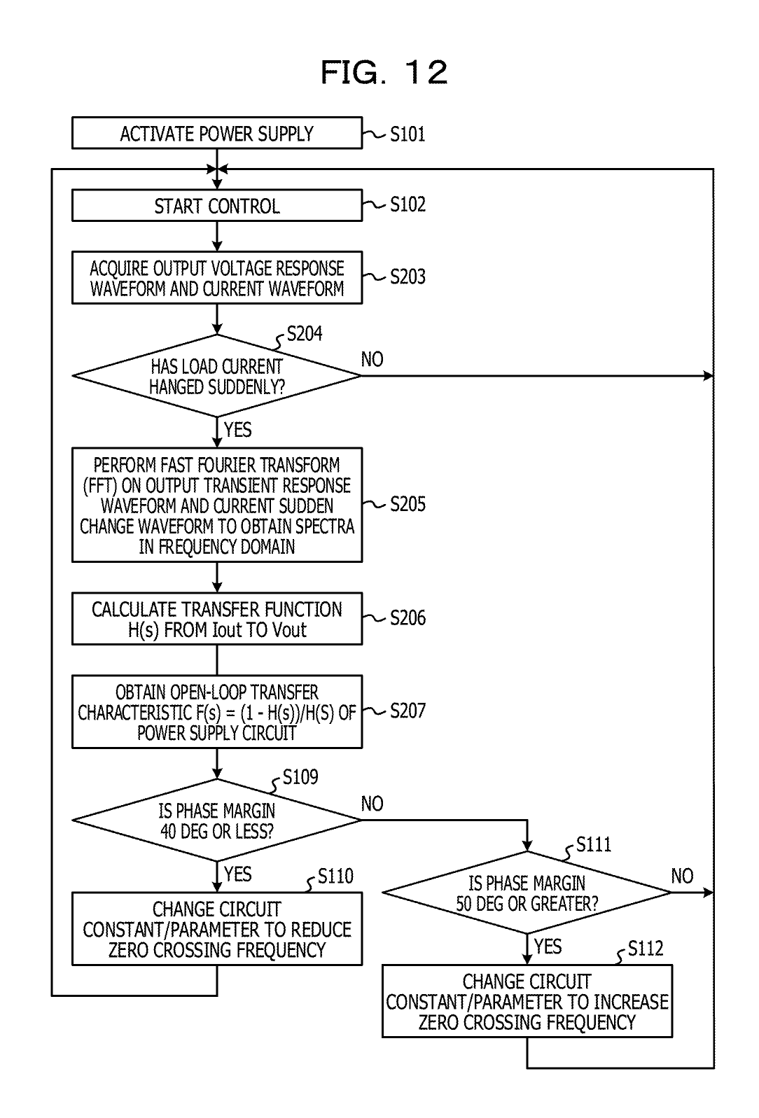

FIG. 12 illustrates an example of control performed by the monitoring control circuit. FIG. 12 is a flowchart illustrating optimization control of an open-loop transfer characteristic performed by the monitoring control circuit 40B illustrated in FIG. 10 or 11. Steps that are substantially the same as or similar to those of the control flow illustrated in FIG. 9 may be denoted by the same reference numerals. When the power supply circuit 20 is activated (S101), control is started (S102), and a voltage waveform of an output voltage Vout of the power supply circuit 20 and a current waveform of a load current Iout of the load device 30 are measured (S203). A change in the current waveform is monitored, and it is determined whether or not the load current Iout has changed beyond a certain level (S204). When a fluctuation in the current waveform is within the certain level (NO in S204), the process returns to S102, and the process is repeatedly performed.

When the load current Iout changes beyond the certain level (YES in S204), the output voltage waveform and the current waveform are subjected to an FFT, and spectra in a frequency domain are obtained (S205). From the ratio between the voltage waveform and the current waveform subjected to the FFT, a transfer function H(s) from Iout to Vout is calculated (S206). Based on the transfer function H(s), an open-loop transfer characteristic F(s) of the power supply circuit 20 is calculated from the expression (4) (S207).

From the obtained open-loop transfer characteristic F(s), control corresponding to a phase margin is performed (S109 to S112). For example, when a phase margin is a first threshold value or less (for example, 40° or less) (YES in S109), a circuit constant or parameter of the phase compensator 22 is changed, and a zero crossing frequency decreases, thereby giving higher priority to the stabilization of the output voltage (S110). When the phase margin is greater than 40° and less than a second threshold value (for example, less than) 50° (NO in S109 and NO in S111), it is determined that the phase margin is within an appropriate range, the process returns to S102, and the control is repeatedly performed. When the phase margin is 50° or greater (YES in S111), a circuit constant or parameter of the phase compensator 22 is changed to increase a zero crossing frequency (S112). An increase in zero crossing frequency improves the capability of following a load fluctuation (a response characteristic).

In this way, an open-loop transfer characteristic itself of the power supply circuit 20 is measured in real time by monitoring a current fluctuation in the load device 30, and a phase margin is maintained within an appropriate range. This improves the response characteristic of the power supply circuit 20, and stabilizes an output voltage. When an open-loop transfer characteristic of the power supply circuit 20 is measured, a circuit constant or parameter of the phase compensator 22 is adjusted or changed in accordance with the measurement result (see S110 or S112 in FIGS. 9 and 12).

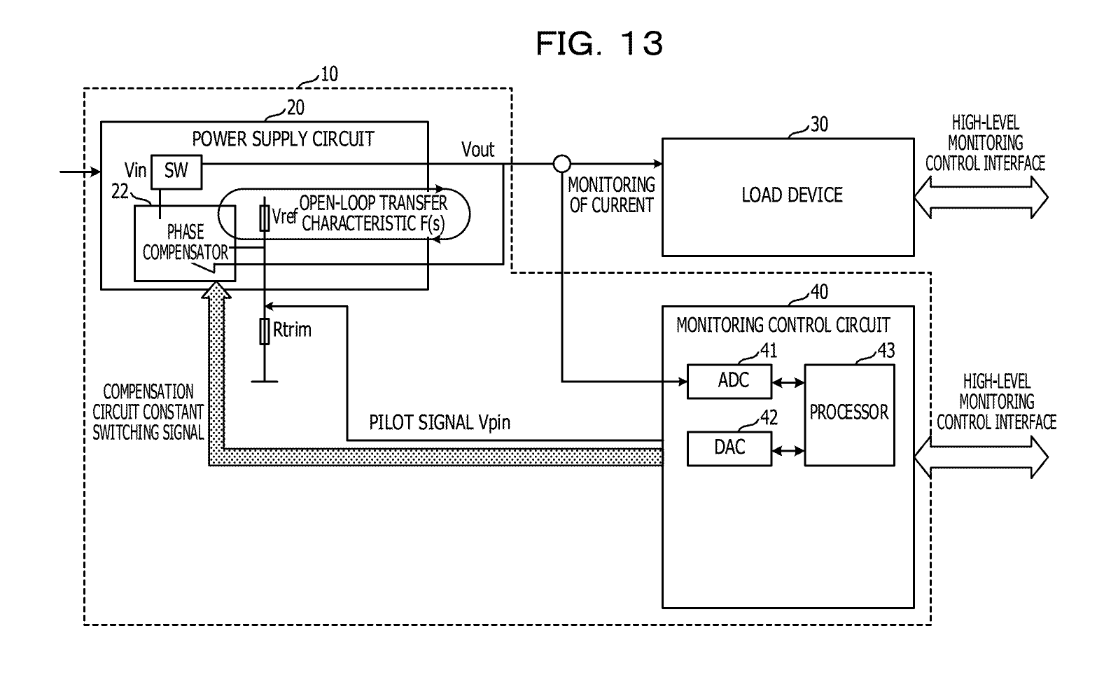

FIG. 13 illustrates an example of supply of a control signal. FIG. 13 illustrates supply of a control signal from a monitoring control circuit 40 to the phase compensator 22. Although a power supply apparatus 10 includes both the configurations illustrated in FIGS. 7 and 10, either of the configurations may be used. When either of the configurations is used, a control signal for switching a circuit constant (a control parameter for digital control) of the phase compensator 22 in accordance with a measurement result of an open-loop transfer characteristic of the power supply circuit 20 is output.

When it is determined that a phase margin is sufficient (for example, 50° or greater) from a measurement result of the open-loop transfer characteristic, a control signal that increases a zero crossing frequency is output. The control signal contains, for example, a command to increase a gain of the phase compensator 22, or a command to increase a frequency of a pole of a phase compensation characteristic.

When the phase margin is small (for example 40° or less), a control signal that reduces a zero crossing frequency is output. The control signal contains, for example, a command to reduce a gain of the phase compensator 22, or a command to reduce a frequency of a pole of a phase compensation characteristic.

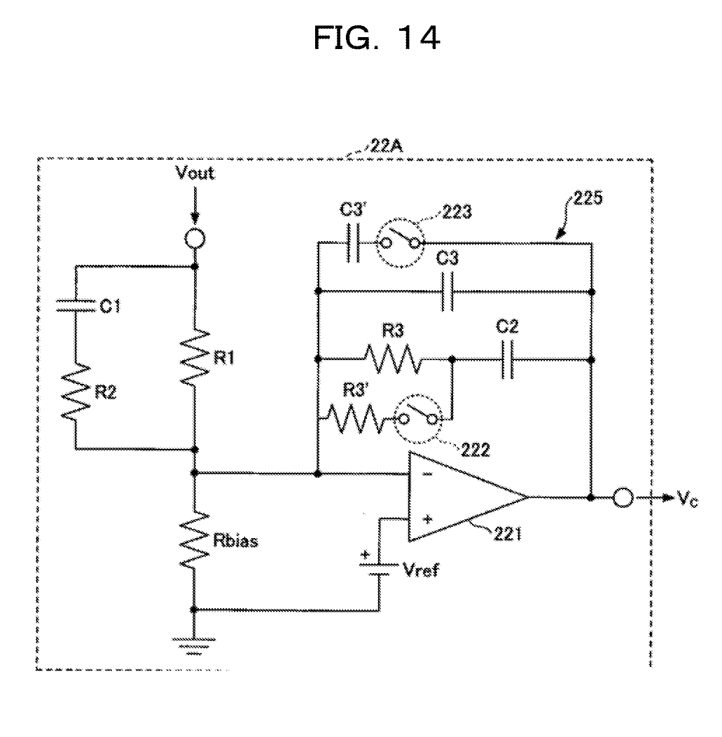

FIG. 14 illustrates an example of a phase compensator. FIG. 14 illustrates a phase compensator 22A constituted by an analog circuit. An output voltage Vout input to the phase compensator 22A is connected to a first input of a comparator 221, and is compared with a reference voltage Vref of a second input. An output of the comparator 221 is output as a power supply voltage Vc to the conversion unit SW of the power supply circuit 20 (see FIG. 13), and is fed back to the first input of the comparator 221 by a feedback loop 225.

In the feedback loop 225, a resistor R3′ is connected in parallel with a resistor R3, a switch 222 is disposed between the resistors R3 and R3′. A capacitor C3′ is connected in parallel with a capacitor C3, and a switch 223 is disposed between the capacitors C3 and C3′.

A control signal supplied to the phase compensator 22A contains a switching command corresponding to a measured open-loop transfer characteristic. The switch 222 and/or the switch 223 are turned on or off by the control signal (indicated as “compensation circuit constant switching signal” in FIG. 13). When the switch 223 is turned on, capacitance is changed from the capacitance of C3 to the capacitance of C3 +C3′. When the switch 222 is turned on, resistance is changed from the resistance of R3 to the resistance of 1/[(1/R3)+(1/R3′)]. The positions and the number of switches are not limited to those of the example illustrated in FIG. 14, and a capacitor C2 may be adjusted, or either the capacitor C3 or the resistor R3 may be switched. The number of stages connected in parallel with the resistor R3, the capacitor C3, or the like may be increased.

In the case where control of the power supply circuit 20 is performed in digital form, an optimal phase compensation parameter is supplied as a control signal, instead of switching a circuit constant.

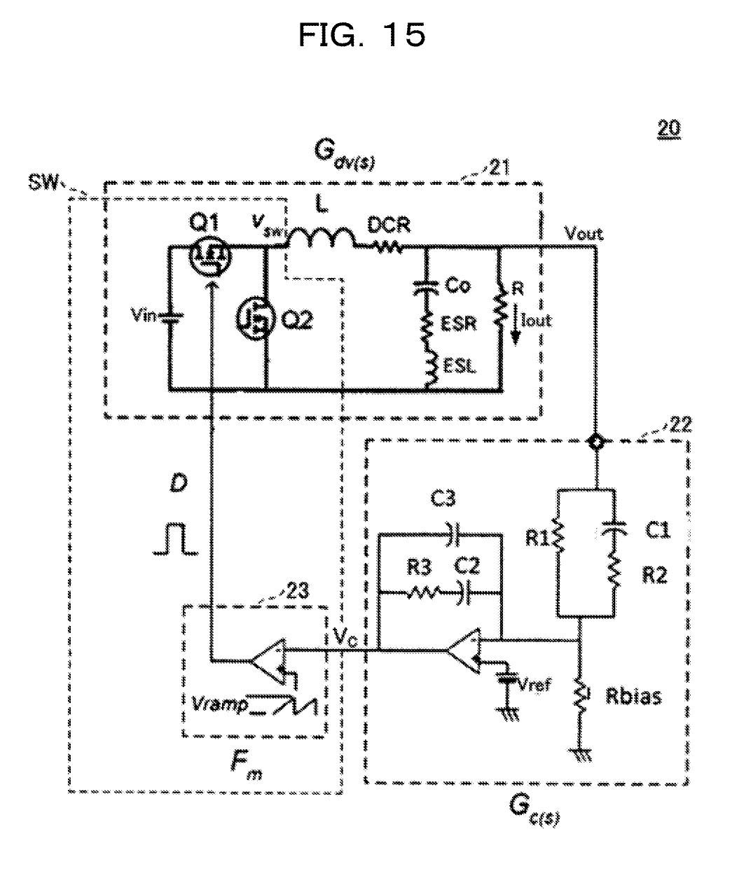

FIG. 15 illustrates an example of an equalization circuit. FIG. 15 illustrates an equalization circuit for the case where the power supply circuit 20 is implemented by a power supply module using digital control. The equalization circuit may have the same parts as the circuit model 120M illustrated in FIG. 4. The equalization circuit is different from the circuit model 120M in the fact that a parameter (a load element, such as R or C) of the phase compensator 22 is adjusted or controlled by a control signal corresponding to a measurement result of an open-loop transfer characteristic to achieve an optimal response characteristic.

The phase compensator 22 compares an output voltage Vout from a power stage 21 with a reference voltage Vref, and outputs a power supply signal Vc indicating a comparison result. The power supply signal Vc turns a transistor Q1 of the power stage 21 on and off through a drive circuit 23. An input voltage Vin is converted by the turning on and off of the transistor Q1. The converted voltage is smoothed by a filter composed of a transistor Q2, an inductor L, and a capacitor C₀, and is connected to the resistor R as an output voltage Vout. A current Iout flowing to the resistor R corresponds to a load current flowing to the load device 30. Simulation is performed using this equalization circuit. In simulation, characteristics of the following circuits are compared. These circuits are (a) a power supply circuit designed to operate optimally in a high current state, (b) a power supply circuit designed to operate with stability both at a high current and at a low current, and (c) a power supply circuit that adjusts or changes a circuit constant or parameter of the phase compensator in accordance with a measurement value of an open-loop transfer characteristic.

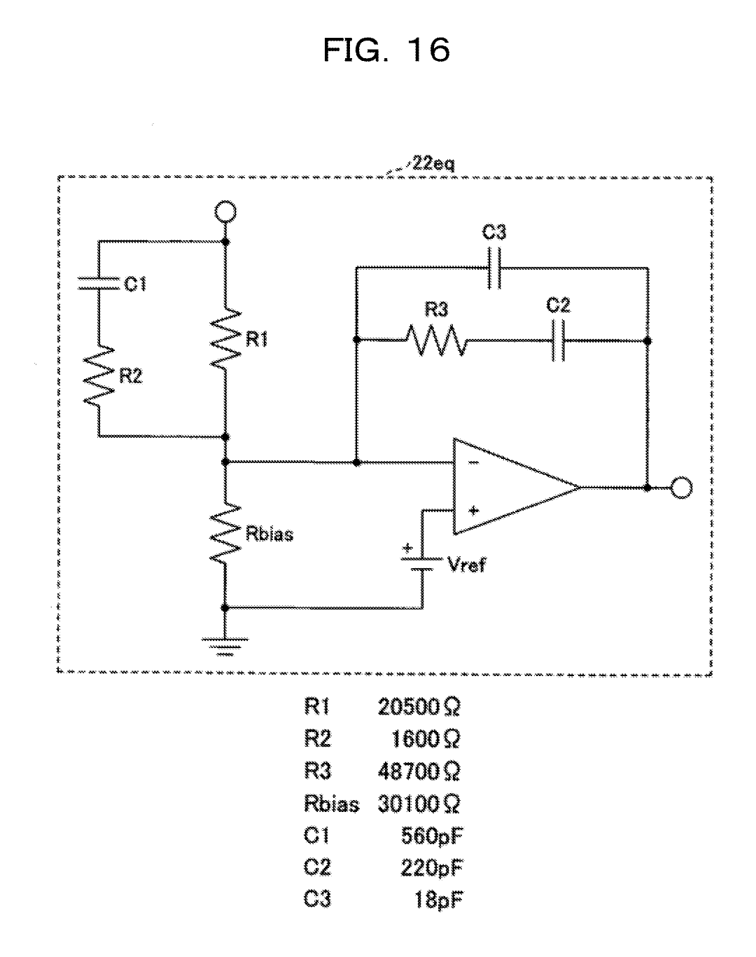

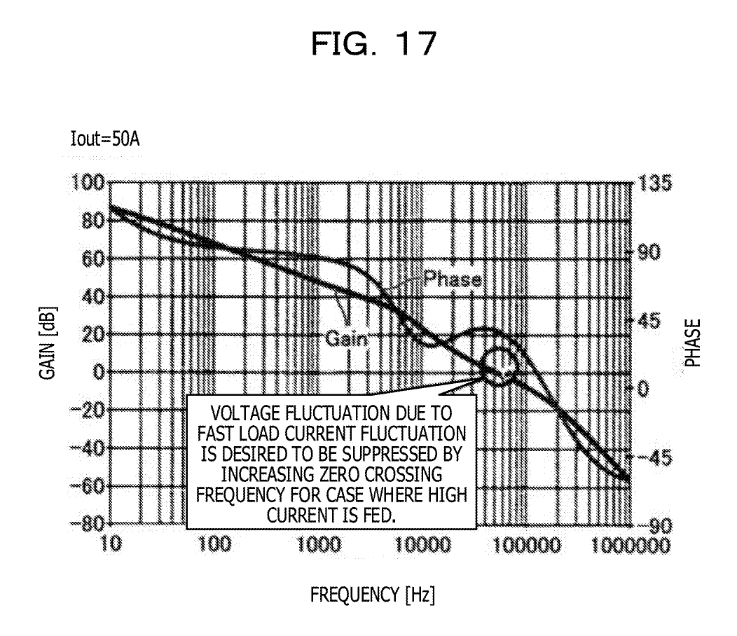

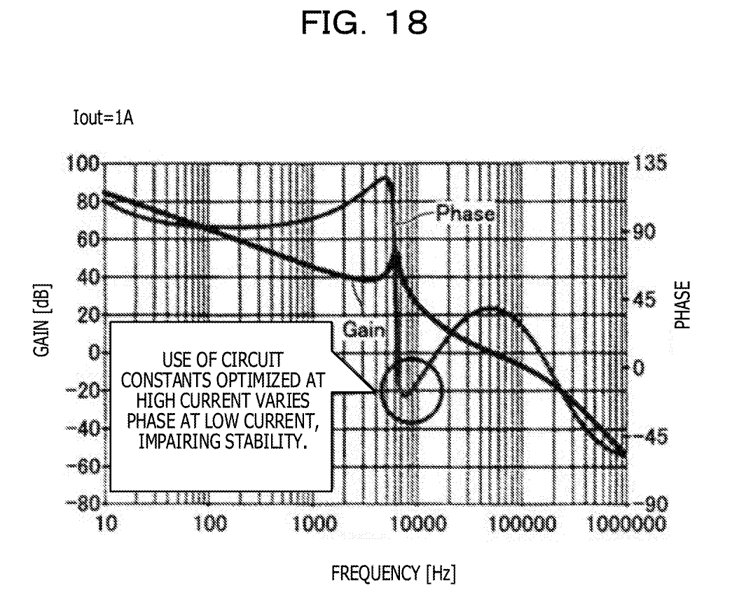

FIG. 16 illustrates an example of parameters of a phase compensation circuit. FIG. 16 illustrates an equalization circuit 22eq of the phase compensator in which constants are designed to achieve wide bandwidth and optimal stability in a high current state, and indicates parameter values set in respective load elements. FIG. 17 illustrates an example of an open-loop transfer characteristic exhibited when a high current flows in the circuit illustrated in FIG. 16. FIG. 18 illustrates an example of an open-loop transfer characteristic exhibited when a low current flows in the circuit illustrated in FIG. 16. FIG. 17 illustrates a simulation result of the open-loop transfer characteristic exhibited when a load current Iout is 50 A in the equalization circuit 22eq. FIG. 18 illustrates a simulation result of the open-loop transfer characteristic exhibited when a load current Iout is 1 A in the equalization circuit 22eq.

In the case where the circuit illustrated in FIG. 16 is used, although a phase margin is left at a high current (50 A) (FIG. 17), a phase lag increases when a current is low (FIG. 18), resulting in an unstable system. That is, unless a sufficiently large phase margin is initially designed, the state illustrated in FIG. 18 may occur.

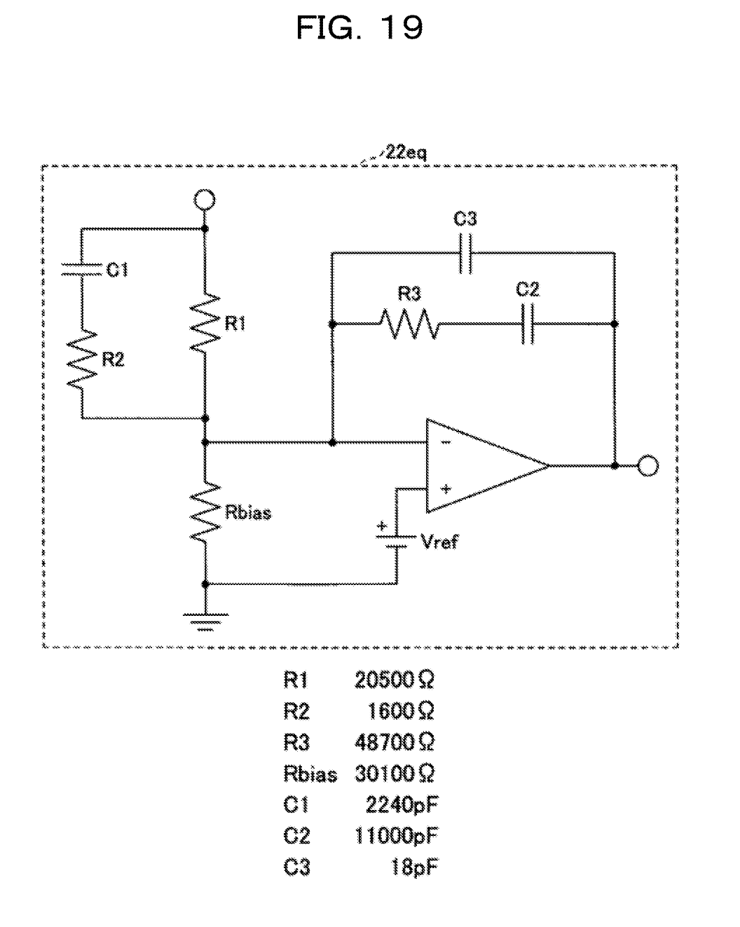

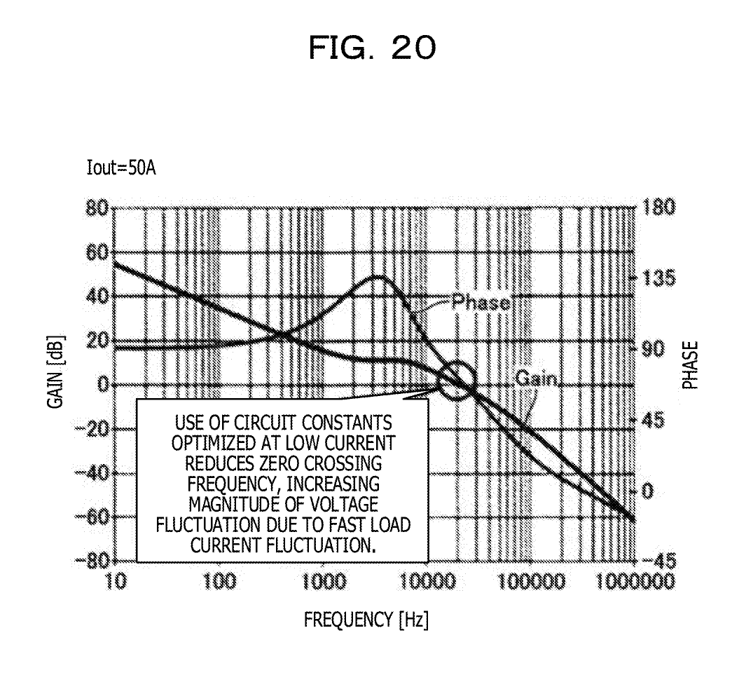

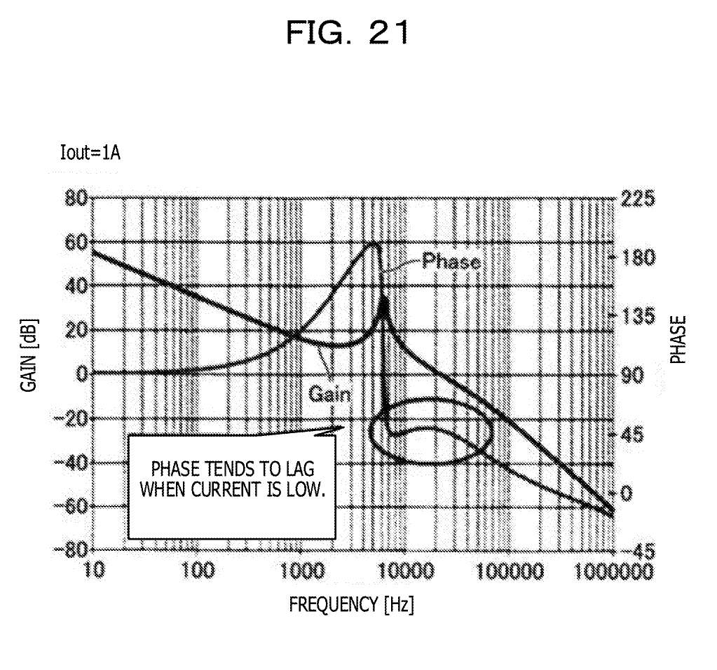

FIG. 19 illustrates an example of parameters of the phase compensation circuit. FIG. 19 illustrates the equalization circuit 22eq of the phase compensator in which constants are designed to achieve stability both at a high current and at a low current, and indicates parameter values set in the respective load elements. FIG. 20 illustrates an example of an open-loop transfer characteristic exhibited when a high current flows in the circuit illustrated in FIG. 19. FIG. 21 illustrates an example of an open-loop transfer characteristic exhibited when a low current flows in the circuit illustrated in FIG. 19. FIG. 20 illustrates a simulation result of the open-loop transfer characteristic exhibited when a load current Iout is 50 A in the equalization circuit 22eq illustrated in FIG. 19. FIG. 21 illustrates a simulation result of the open-loop transfer characteristic exhibited when a load current Iout is 1 A in the equalization circuit 22eq illustrated in FIG. 19.

As illustrated in FIGS. 20 and 21, a certain degree of phase margin is left both at a high current (50 A) and at a low current (1 A). For example, in the case of the high current illustrated in FIG. 20, a zero crossing frequency is lower than that in FIG. 17, impairing high-speed responsivity. In the case of the low current illustrated in FIG. 21, a zero crossing frequency is also lower than that in FIG. 18 (a reduction in high-speed responsivity), and a phase tends to lag (a reduction in stability).

With the circuit illustrated in FIG. 19, such as a circuit in which constants are set to achieve stability both at a high current and at a low current, as a basis, an open-loop transfer characteristic of the power supply circuit is measured during operation, and a circuit constant of the phase compensator is switched in accordance with a measurement result. For example, as a measurement result of the open-loop transfer characteristic, when a phase margin is sufficient, a circuit constant is switched in the direction of increasing a loop gain, speeding up a response characteristic. A loop gain is achieved by increasing a parameter R3 or the like of the phase compensator 22 illustrated in FIG. 19, for example. In the case of an analog circuit like that in FIG. 14, the switch 222 is turned on to increase the resistance of the resistor R3.

When the phase margin is a threshold value or less, a circuit constant is switched in the direction of reducing the loop gain (the direction of reducing a zero crossing frequency), leaving a phase margin.

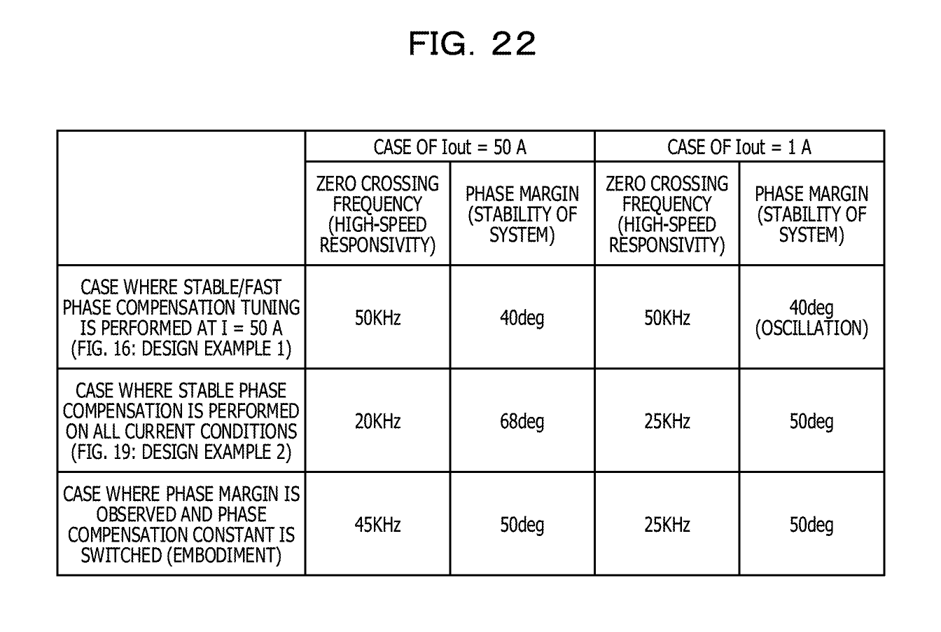

FIG. 22 illustrates an example of improvements in response characteristic and stability. FIG. 22 illustrates comparison results among the circuit design illustrated in FIG. 16 (a design example 1), the circuit design illustrated in FIG. 19 (a design example 2), and the configuration illustrated in FIG. 14. At a high current (Iout=50 A) and at a low current (Iout=1 A), respective zero crossing frequencies (high-speed responsivity) and respective phase margins (stability of a system) are indicated. The high-speed responsivity improves as a zero crossing frequency increases. The system is stabilized as a value of a phase margin increases.

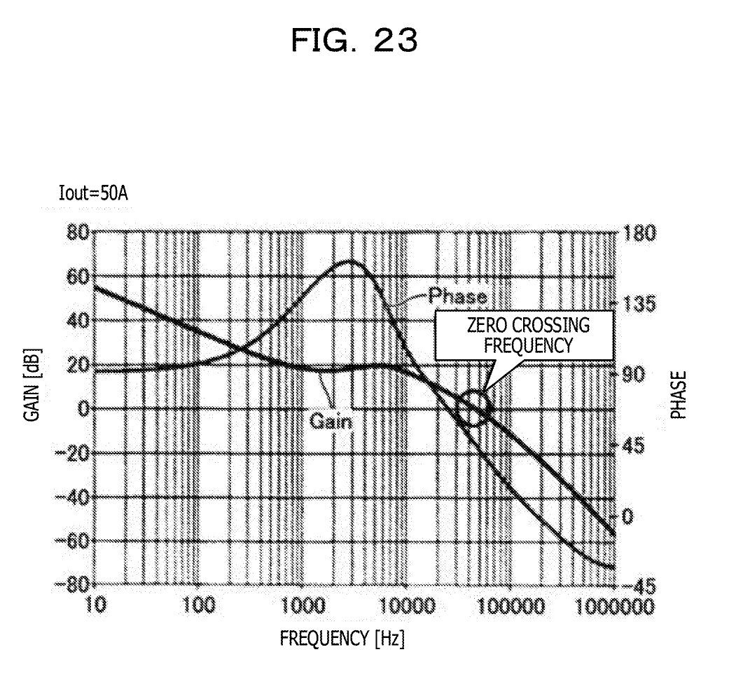

In the design example 1, a phase margin is not left when a low current flows, and an output voltage oscillates. In the design example 2, although a sufficient phase margin is left, the response characteristic is poor. In the configuration illustrated in FIG. 14, when phase rotation is reduced due to, for example, an increase in current, a zero crossing frequency is increased by increasing a parameter of the resistor R3 or the like, resulting in an improvement in response characteristic (an improvement from 20 kHz to 45 kHz in the example in FIG. 22). When a low current flows, response speed is slightly reduced, and thus the stability is achieved. FIG. 23 illustrates an example of improvements in response characteristic and stability. FIG. 23 illustrates a simulation result of an open-loop transfer characteristic exhibited when a load current Iout is 50 A in an equalization circuit 22A.

Even in the case where a response characteristic and stability are degraded due to a change in current or external factors, an open-loop characteristic is maintained optimally based on a measurement result of the open-loop characteristic of the power supply circuit. Thus, the high-speed responsivity and stability of the power supply circuit are achieved.

The control flow performed by the monitoring control circuit 40A or 40B may be performed by causing the processor 43 to execute a power supply control program stored in the memory 45. In this case, the power supply control program causes the processor 43 to execute a process of monitoring an open-loop transfer characteristic F(s) of the power supply circuit 20 that converts an input voltage value into another voltage value to generate an output voltage, and a process of controlling a characteristic of the power supply circuit 20 to put it into an optimal state in accordance with a monitoring result of the open-loop transfer characteristic F(s).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A power supply apparatus comprising:
a power supply circuit, including a switch configured to perform switching at a frequency, configured to generate an output voltage to be supplied to a load device;
a phase compensator configured to perform feedback control of switching duty of the switch in accordance with the output voltage, and change a response characteristic of the output voltage to a load fluctuation of the load device in accordance with a reference voltage and the output voltage; and
a controller configured to apply a pilot signal over a frequency range to the reference voltage, monitor the output voltage, and control the response characteristic in accordance with the pilot signal and the output voltage.

2. The power supply apparatus according to claim 1, wherein the controller is configured to obtain an open-loop transfer characteristic of the power supply circuit in accordance with the pilot signal and the output voltage, and output a control signal that reduces a gain or a zero crossing frequency of the power supply circuit to the phase compensator when a phase margin of the open-loop transfer characteristic is a first threshold value or less.

3. The power supply apparatus according to claim 1, wherein the controller is configured to obtain an open-loop transfer characteristic of the power supply circuit in accordance with the pilot signal and the output voltage, and output a control signal that increases a gain or a zero crossing frequency of the power supply circuit to the phase compensator when a phase margin of the open-loop transfer characteristic is a second threshold value or greater.

4. The power supply apparatus according to claim 1,
wherein the controller is configured to:
generate the pilot signal over the frequency range;
output the pilot signal to the phase compensator;
measure a phase and an amplitude of the pilot signal contained in the output voltage; and
calculate an open-loop transfer characteristic of the power supply circuit in accordance with measurement results of the phase and the amplitude.

5. The power supply apparatus according to claim 1,
wherein the controller is configured to:
monitor the output voltage and an output current of the power supply circuit; and
calculate an open-loop transfer characteristic of the power supply circuit in accordance with a change in the output voltage occurring when the output current changes beyond a level.

6. The power supply apparatus according to claim 1,
wherein the power supply circuit includes a feedback loop including the switch, and
wherein the phase compensator performs the feedback control of switching duty of the switch so that a fluctuation in the output voltage decreases, and a control signal output from the controller changes the reference voltage of the phase compensator.

7. The power supply apparatus according to claim 1,
wherein the controller is configured to:
calculate a transfer function from an input of the pilot signal to the power supply circuit to an output of the pilot signal from the power supply circuit in accordance with the pilot signal and the output voltage; and
calculate an open-loop transfer characteristic in accordance with the transfer function.

8. The power supply apparatus according to claim 1,
wherein the power supply circuit includes a variable resistor disposed between the reference voltage and ground, and
wherein the pilot signal is applied between the reference voltage and the variable resistor.

9. The power supply apparatus according to claim 1,
wherein the phase compensator includes a load element, and
wherein a parameter value of the load element is changed in accordance with a control signal supplied from the controller.

10. A power supply control method, comprising:
generating an output voltage to be supplied to a load device in a power supply circuit by switching of a switch at a frequency;
performing feedback control of switching duty of the switch in accordance with the output voltage;
varying a response characteristic of the output voltage to a load fluctuation of the load device in accordance with a reference voltage and the output voltage;
applying a pilot signal over a frequency range to the reference voltage;
monitoring the output voltage; and
controlling the response characteristic in accordance with the pilot signal and the output voltage.

11. The power supply control method according to claim 10, further comprising:
obtaining an open-loop transfer characteristic of the power supply circuit in accordance with the pilot signal and the output voltage; and
outputting a control signal that reduces a gain or a zero crossing frequency of the power supply circuit to the phase compensator when a phase margin of the open-loop transfer characteristic is a first threshold value or less.

12. The power supply control method according to claim 10, further comprising:
obtaining an open-loop transfer characteristic of the power supply circuit in accordance with the pilot signal and the output voltage; and
outputting a control signal that increases a gain or a zero crossing frequency of the power supply circuit to the phase compensator when a phase margin of the open-loop transfer characteristic is a second threshold value or greater.

13. The power supply control method according to claim 10, further comprising:
generating the pilot signal over the frequency range;
outputting the pilot signal to the phase compensator;
measuring a phase and an amplitude of the pilot signal contained in the output voltage; and
calculating an open-loop transfer characteristic of the power supply circuit in accordance with measurement results of the phase and the amplitude.

14. The power supply control method according to claim 10, further comprising:
monitoring the output voltage and an output current of the power supply circuit; and
calculating an open-loop transfer characteristic of the power supply circuit in accordance with a change in the output voltage occurring when the output current changes beyond a level.

15. The power supply control method according to claim 10,
wherein the power supply circuit includes a feedback loop including the switch, and
wherein the feedback control of switching duty of the switch is performed so that a fluctuation in the output voltage decreases, and a control signal output from the controller changes the reference voltage of the phase compensator.

16. The power supply control method according to claim 10, further comprising:
calculating a transfer function from an input of the pilot signal to the power supply circuit to an output of the pilot signal from the power supply circuit in accordance with the pilot signal and the output voltage; and
calculating an open-loop transfer characteristic in accordance with the transfer function.

17. The power supply control method according to claim 10,
wherein the power supply circuit includes a variable resistor disposed between the reference voltage and ground, and
wherein the pilot signal is applied between the reference voltage and the variable resistor.
